(19) United States
(12) Patent Application Publication
(10) Pub. No.: US 2010/0018586 A1
(43) Pub. Date: Jan. 28, 2010

(54) SYSTEM AND METHOD FOR MATERIAL DISTRIBUTION IN AN AQUATIC ENVIRONMENT

(76) Inventors: Thomas J. McNabb, Martinez, CA (US); Thomas G. Moorhouse, Coeur d'Alene, ID (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/574,496

(22) Filed: Oct. 6, 2009

Related U.S. Application Data
(63) Continuation-in-part of application No. 12/132,398, filed on Jun. 3, 2008.
(60) Provisional application No. 61/180,356, filed on May 21, 2009.

(51) Int. Cl. A01M 21/04; B60P 3/22; B60P 3/30

(52) U.S. Cl. 137/236.1; 137/899.2; 137/355.12; 137/355.16

(57) ABSTRACT

A system for the application of material such as pesticides, herbicides, and the like, within a body of water. The system includes a conduit extending into the body of water and having a distal end for discharging material into the body of water. The conduit is coupled to an adjustable fixture for adjusting the length of the conduit, which in turn adjusts the depth at which the material is applied to the body of water. The conduit is also coupled to a material handling system for regulating the flow of material to the conduit and out the distal end. The system may be mounted on a vessel that includes electronic controls and guidance systems for controlling the application of material.

### CROSS-REFERENCE TO RELATED APPLICATIONS

This application is a continuation-in-part of U.S. patent application Ser. No. 12/132,398 filed Jun. 3, 2008, and claims the benefit of and priority to U.S. Provisional Patent Application No. 61/180,356 filed May 21, 2009. The entire contents of the foregoing applications are hereby incorporated by reference.

### BACKGROUND OF THE INVENTION

The present invention relates to systems and methods for distributing materials in an aquatic environment.

Pesticides, herbicides, larvacides, adulticides, mulluscicides, algaecides, piscides, aluminum sulfate, nutrient inactivation compounds, water quality improvement compounds, and various other products in liquid and granular form (collectively hereinafter, “pesticides”) are known for the control of aquatic vegetation, insects, mussels, algae, fish, nutrient fluctuations, and water quality enhancement, to name a few. One known method of distributing pesticides within a body of water (e.g., lakes, rivers, ponds, reservoirs, bays and impoundments, oceans, and estuaries) is to spray or otherwise spread the pesticide on the surface of the body of water. In the case of liquid pesticides, the pesticide may be sprayed from a vessel onto the surface of the body of water or slightly below the surface of the body of water and allowed to diffuse through the water column. In the case of granular pesticides, the pesticide may be spread using known granular spreaders that distribute the granular product on the surface of the body of water. The granular product then sinks through the water column, gradually dissolving and releasing pesticide along the way.

Another known method of applying pesticide to a body of water is the use of weighted trailing hoses. In a weighted trailing hose application, a series of hoses are coupled to a manifold that is carried by a water-going vessel. The manifold is mounted to extend substantially perpendicular to the direction of travel. One end of each hose is coupled to the manifold, and the opposite end of each hose is placed on the water. The hoses are spaced apart along the length of the manifold. The manifold distributes pesticide to each of the weighted hoses. The hoses each have a fixed length that substantially corresponds to the desired depth of pesticide application. The hoses are weighted at their distal ends so that as the vessel moves through the water the hoses extend in a vertical or nearly vertical downward direction to the desired depth within the water column. One known weighting technique includes coupling a 2-foot length of ¾ inch diameter pipe filled with lead to the distal end of the hose. A small opening is formed just above the pipe for discharge of the pesticide.

Another known weighting method includes coupling a series of brass nipples and a cap to the end of the hose. The cap is drilled with a 0.16-inch orifice for the discharge of the pesticide. For satisfactory results using these known weighted hose methods, it has been found that at least about 6.5 lbs. of weight must be added to the end of each hose, and that the vessel speed cannot exceed about 2 mph.

### SUMMARY

In some aspects, the invention may provide a material distribution system for distributing material in a body of water. The body of water includes a surface, and the material distribution system is supportable by a vessel and moveable therewith relative to the body of water during material distribution. The material distribution system includes a container for holding material, a conduit fitting, and a material distribution conduit supported by the conduit fitting. The material distribution conduit includes a proximal end communicating with the container and a distal end positioned in the body of water for the distribution of material into the body of water. The material distribution conduit includes a conduit length extending between the conduit fitting and the distal end, and the conduit length is adjustable.

In other aspects, the invention may provide a method of adjusting a material discharge depth of an aquatic material distribution system. The method includes extending a material distribution conduit downwardly and rearwardly from a conduit fitting that is supported by a vessel and that is conveyed with the vessel along a body of water. The method also includes adjusting at least one of a rate at which the material distribution system is moved along the body of water and a length of conduit extending between a distal end of the material distribution conduit and the conduit fitting.

In still other aspects, the invention may provide a material distribution system supportable by a vessel and moveable therewith along a body of water for distributing material in the body of water. The material distribution system includes a frame and a container for holding material coupled to the frame. The material distribution system also includes a material handling assembly for regulating a flow of material out of the container. The material handling assembly includes at least one pump for pumping material from the container and at least one valve communicating with the pump. The material distribution system also includes a material distribution conduit having a proximal end that communicates with the container via the material handling assembly and a distal end that is in the body of water for the distribution of material. The material distribution system also includes a conduit fitting coupled to the frame and moveable between an extended position and a retracted position. The conduit fitting supports the material distribution conduit and is operable to change a conduit length that is defined between the conduit fitting and the distal end of the material distribution conduit. The material distribution system also includes a depth sensor for sensing the depth of the distal end, and a control system communicating with the depth sensor. The control system is operable to control the at least one pump and the at least one valve to adjust a material distribution rate, and is also operable to control the conduit fitting to change the conduit length. By changing at least one of the conduit length and a rate at which the material distribution system is moved along the body of water, a material distribution depth is adjusted. The rate at which the material distribution system is moved along the body of water is at least about 3 mph and up to about 10 mph, and an included angle between a horizontal plane defined generally by a surface of the water and an axis extending from the distal end of the material distribution conduit to a point at which the material distribution conduit intersects the horizontal plane is less than 45 degrees during operation of the material distribution system to distribute material in the body of water.

### BRIEF DESCRIPTION OF THE DRAWINGS

FIG. 1 is a side-view schematic representation of a vessel distributing pesticide within a body of water using a material distribution system embodying the invention.

FIG. 2 is a top view schematic representation of the vessel of FIG. 1.

FIG. 3 is a side view of a vessel including the material distribution system embodying the invention.

FIG. 4 is a perspective view of an aft portion of the vessel of FIG. 3 showing components of the material distribution system.

FIG. 5 is a chart illustrating material discharge depths corresponding to various lengths of conduit for a variety of vessel speeds.

FIG. 6 is a perspective view of a control system for regulating operation of the material distribution system.

### DETAILED DESCRIPTION

It is to be understood that the invention is not limited in its application to the details of construction and the arrangements of the components set forth in the following description or embodiments, or illustrated in the drawings. The invention is capable of other embodiments and of being practiced or being carried out in various ways. Also, it is to be understood that the phraseology and terminology used herein is for the purpose of description and should not be regarded as limiting.

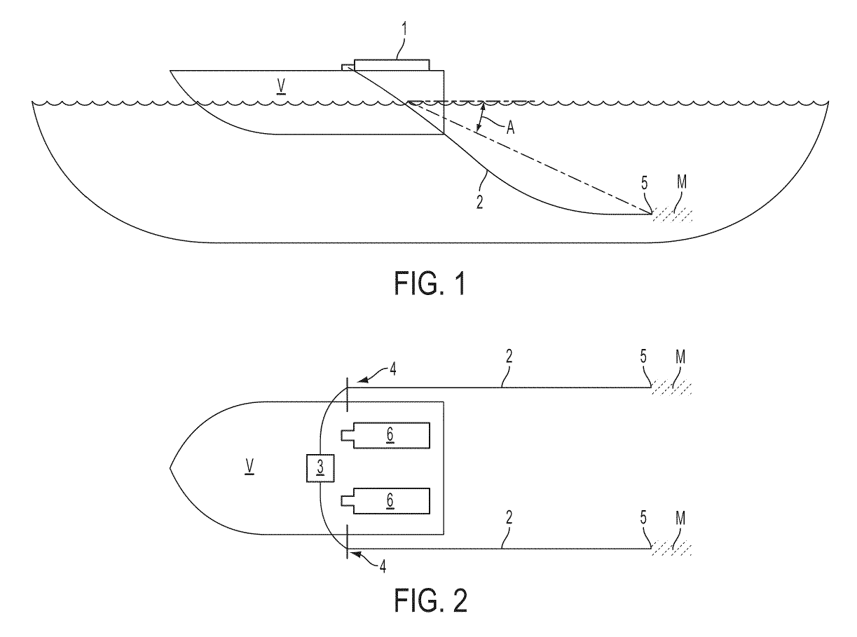

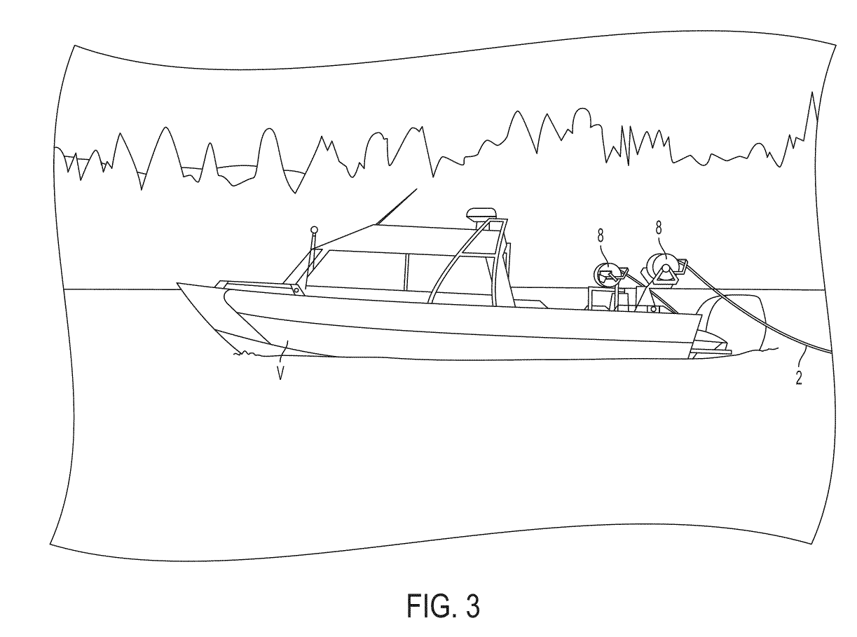

FIGS. 1 and 2 schematically illustrate a vessel V distributing material within a body of water using a material distribution system 1. Examples of the types of materials that may be distributed by the system 1 include pesticides, herbicides, larvacides, adulticides, mulluscicides, algaecides, piscides, aluminum sulfate, nutrient inactivation compounds, water quality improvement compounds, and various other products that may be provided in liquid and/or granular form. In the illustrated construction, the material distribution system 1 includes a pair of trailing material conduits in the form of hoses 2 that extend downwardly and rearwardly from the vessel V. The hoses 2 each include a distal end 5 that discharges material M into the body of water at a selected depth. During operation and when the system is viewed from the side as in FIG. 1, an angle A, formed between a horizontal plane defined generally by the surface of the water and an imaginary line drawn between the distal end 5 and the point at which the hose 2 enters the water, is less than 45 degrees.

The hoses 2 are coupled to the vessel V at fittings 4, which as discussed below can be adjusted to vary the length of the hoses 2 extending from the vessel V, which in turn varies the depth at which the hoses discharge material into the body of water. Each hose 2 is also fluidly coupled to a material handling assembly 3 that regulates the flow of material through the hoses 2. In the illustrated construction, two storage tanks 6 are carried by the vessel V and supply material to the material handling assembly 3 for subsequent distribution to the hoses 2.

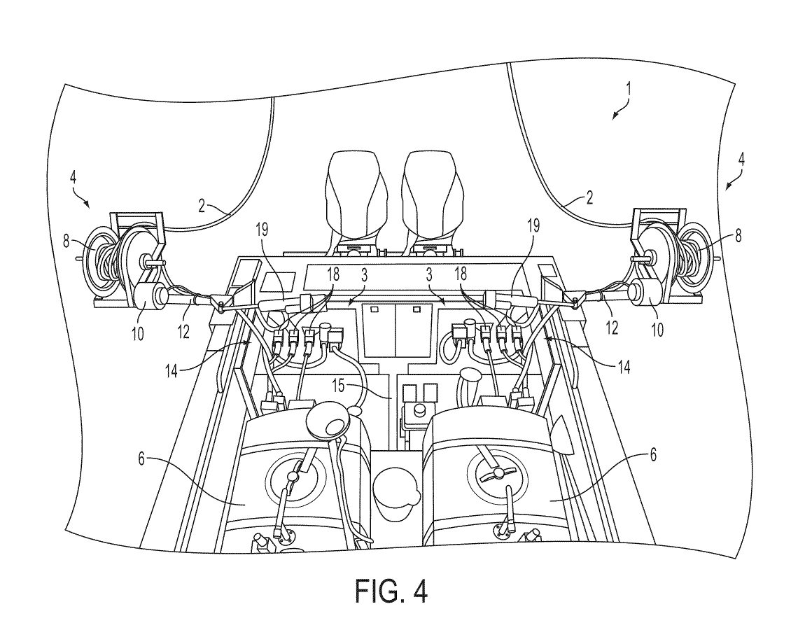

With reference also to FIGS. 3 and 4, in some embodiments, the vessel V is in the form of an outboard motor boat. It should be appreciated, however, that the material distribution system 1 may be used with substantially any suitable water-borne vessel, including pontoon type boats, barges, and the like, depending upon a particular application. Furthermore, for application into a canal, channel, or other relatively narrow waterway, the material distribution system 1 may be installed on a land-going vessel such as a vehicle or rolling carriage, in which case the material distribution system 1 would be operated by moving the vehicle or carriage adjacent the canal or channel with the hose or hoses 2 extending into the water.

In the illustrated construction, the fittings 4 include hose spool assemblies 8 that allow for adjustment of the length of hose 2 extending from the vessel V. The spool assemblies 8 are configured such that a fluid input coupling connected to the material handling system 3 remains stationary as hose 2 is wound onto and off of the spool. The spool assemblies 8 may also include electric or hydraulic motors 10 that allow for automatic adjustment of the length of hose 2, as discussed further below. Each spool assembly 8 is mounted to an arm 12 that is moveable between a deployed position (as illustrated) in which the spool assemblies 8 extend outwardly and beyond the sidewalls of the vessel V, and a retracted position in which the spool assemblies 8 are positioned inwardly of the sidewalls when the system 1 is not in use. Electronic or hydraulic actuators 19 may be coupled to the arms 12 to move the arms 12 and spool assemblies 8 between the extended and retracted positions. Although spool assemblies 8 are well suited to allow for automatic adjustment of the length of hose 2, in some embodiments the spool assemblies 8 may be adjusted manually, or may be removed altogether. In such cases the length of the hose 2 may be adjusted by clamping or otherwise securing the hose to the vessel V or arms 12 to achieve the desired rearwardly extending length of hose 2.

In the illustrated construction, the arms 12 are mounted to a frame 15 that also carries the material handling assembly 3 and the storage tanks 6. In this way, the entire material distribution system can be installed in and removed from the vessel V as a single unit. The material handling assembly 3 can take on a variety of configurations, but generally will include at least one pump for pumping material from the storage tank or tanks 6 to the hose or hoses 2, and at least one regulating valve for regulating the flow of material to/from the pump to thereby regulate the flow of material through the hoses. The storage tank or tanks 6 can be substantially any tank of a suitable size and construction for holding the material that is to be distributed within the body of water.

In the illustrated construction, the material handling system 3 includes a pair of subassemblies 14 each of which is coupled to a respective one of the storage tanks 6 and a respective one of the hoses 2. Each subassembly 14 includes a pump (hidden from view in FIGS. 3 and 4), a plurality of flow control valves 18, and a variety of fittings and associated plumbing that allow the flow control valves 18 to regulate the flow of material from the storage tank 6 to the pump and from the pump to the hoses 2. In some embodiments the flow control valves 18 may be controlled by solenoids or other actuators to allow for automated and/or electronic control of the operation of the material handling system 3. In other embodiments, the subassembly 14 may include a single, main pump that pumps material from one or both of the tanks 6 to each of the subassemblies 14. In still other embodiments, additional injection pumps may also be provided to inject different materials into different parts of the material flow path between the tanks 6 and the hoses 2.

The material handling system 3 may be configured to operate in different ways for different applications. In some applications, material is pumped directly from the storage tank 6, through the pump, and to the corresponding hose 2. In other applications, each storage tank 6 may include different materials and the material handling system 3 may operate to mix the materials from the tanks prior to distributing the mixed material to the hoses 2. If required, the material handling system 3 may also dilute the material or mixture of materials by adding water drawn directly from the body of water or from another source. In still other applications, each hose 2 may include two or more distinct channels (as discussed below) and the material handling system 3 may be configured to distribute a first material to a first channel, a second material to a second channel, etc. In all cases, the flow control valves 18 may be manually or automatically operated to adjust the flow of material to the hoses, including adjusting the relative ratios of materials when two or more materials are mixed or delivered to distinct channels of a multi-channel hose.

One example of a two channel hose 2 suitable for use with the material distribution system 1 includes the Parker/Dayco Siameez Twin Welding Hose, part number 7126-381. This hose includes two “parallel” or generally co-extensive channels each having an internal diameter of ⅜ inch and an outside diameter of 0.656 inch. The hose also has a weight of approximately 28 lbs per 100 feet. One example of a suitable pump for the material handling system 3 subassemblies 14 includes the Hypro Model 9910-D50GRGI. In embodiments including material injection pumps, one example of suitable injection pumps includes the Mid-Tech Model MT500. The flow control valves 18 may include a wide variety of valve types, including the above-mentioned solenoid control valves, injection valves, check valves, pressure regulators, and the like. The flow control valves 18 may also be distributed throughout the flow path between the tanks 6 and the hoses 2 to control, among other things, the flow rate and concentration of material supplied to the hoses. It should be appreciated that the specific hose 2, pumps 16 and flow control valves 18 identified above are presented by way of example only, and should not be regarded as limiting.

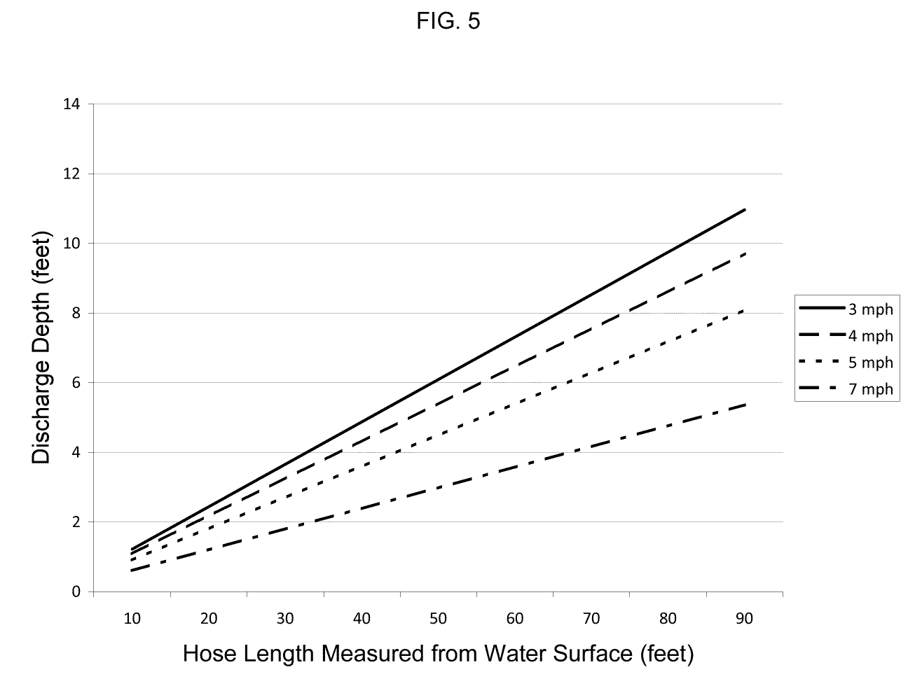

In use, an operator adjusts the speed of the vessel V and the length of hoses 2 extending behind the vessel to adjust the depth within the body of water at which material is discharged from the end of the hoses 2. Vessel speeds using the system 1 generally are at least about 3 mph, and may be as fast as about 10 mph, relative to the body of water. For many applications, vessel speeds in a range of about 3 mph to about 5 mph are appropriate. For example, as illustrated in the chart of FIG. 5, which represents data collected using the Siameez Twin Welding Hose identified above, operation of the vessel V at a speed of approximately 5 mph and a hose length of approximately 40 feet (measured from the point at which the hose enters the water to the distal end 5) results in the discharge of material from the distal end 5 of the hose 2 at a depth of approximately 4 feet below the surface of the water. By increasing the hose length to approximately 80 feet, material is discharged from the distal end 5 of the hose 2 at approximately 7 feet below the surface of the water. Thus, by adjusting the hose length and the speed of the vessel, the depth of the distal end 5, and therefore the depth at which the material is distributed within the body of water, can be controlled. Additional adjustments may also be made to various components of the material handling system 3 to provide a desired flow rate of a desired concentration of material through the hoses 2. Such adjustments may be made manually or automatically using the control system described below.

When the system 1 is operated in the manners described above, even when distributing materials in relatively shallow water or at relatively small depths below the surface of the water, the hose length will be at least twice as long as the depth of the distal end 5. Furthermore, regardless of the hose length and resulting depth of the distal end 5, when the vessel V is operated at the desired speed of at least 3 mph, the angle A (see FIG. 1) will be less than 45 degrees.

A variety of sensors may be utilized to determine the depth of the distal ends 5 of the hoses 2 to aid in adjusting the hose length and vessel speed to discharge material at a desired depth below the surface of the water. For example, a GPS-enabled transmitter may be attached to the distal end to broadcast the position (including depth) of the distal end to a receiver on the vessel. In other embodiments, a depth sensor may be attached to the distal end and may communicate with a receiver mounted in the vessel V wirelessly or via a wire that extends along the hose 2.

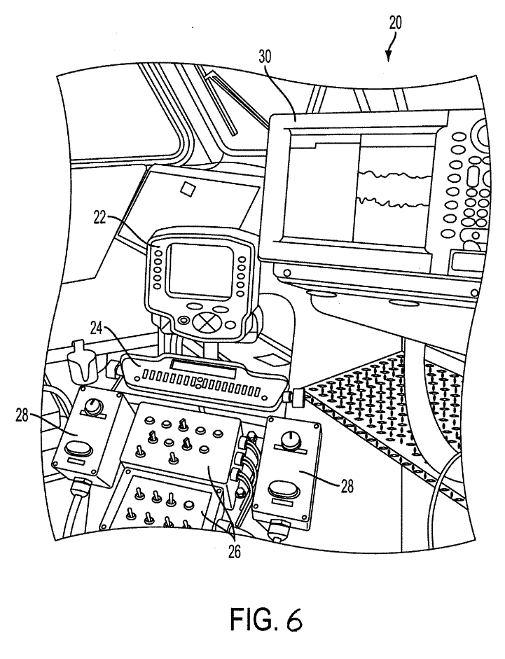

With reference also to FIG. 6, in some embodiments the system 1 also includes an electronic control system 20 for adjusting various system parameters and aiding in the proper distribution of material throughout the body of water. In the illustrated embodiment, the electronic control system 20 includes a material application controller 22, a path guidance indicator 24, a material handling system control panel 26, a pair of hose spool controls 28, and a multi-purpose display panel 30.

The material application controller 22 is a combination hardware/software device that is loaded with information relating to the body of water being treated, the desired treatment area, the material being distributed, the desired rate of material distribution per acre, and the swath width at which the material is being distributed. The material application controller 22 provides the operator with information relating to the material flow rates, vessel speeds, and vessel paths required to achieve the desired treatment. The path guidance indicator 24 provides a visual indication to the operator that helps the operator guide the vessel along the necessary path.

The material handling system control panel 26 includes a plurality of switches that are configured to operate the various solenoids, actuators, pumps, and the like, associated with the material handling system 3. For example, some switches may be configured to actuate certain valves to initiate the flow of material, while other switches may be configured to operate the actuators 19 to move the spool assemblies 8 between the extended and retracted positions. In the illustrated construction, the hose spool controls 28 are rheostat controls that operate the motors 10 to wind and unwind the hoses 2 from the spool assemblies 8 to adjust the length of the hose.

The multi-purpose display panel 30 is configured to display information associated with sensors, controls, and other features of the vessel V and/or the material distribution system 1. Among other things, the display panel 30 may be coupled to a GPS system to display the location of the vessel V in the body of water, and to provide a visual indication of the desired vessel path. The display panel 30 may also be coupled to a sonar device that provides information relating to, among other things, the depth and surface contours of the body of water. The display panel 30 may also be coupled to an underwater camera, or to one of the sensors described above for determining the depth and/or location of the distal ends 5 of the hoses 2.

The above-described material distribution system 1 allows material to be distributed within a body of water at substantially any chosen depth, and in substantially any chosen concentration. In this way, materials for controlling aquatic vegetation, insects, mussels, algae, fish, and nutrient fluctuations can be distributed in the body of water within close proximity of the items they are intended to control. For example, with respect to the control of aquatic vegetation, it is advantageous to be able to vary the depth at which the herbicide is applied to the vegetation. By targeting the application of the herbicide in this way, less herbicide is required to treat a given area within the body of water when compared, for example, with treatments that deposit the material on the surface of the body of water and allow the material to diffuse or sink through the body of water to reach the treatment site.

What is claimed is:

1. A material distribution system for distributing material in a body of water, the body of water having a surface and the material distribution system supportable by a vessel and moveable therewith relative to the body of water during material distribution, the material distribution system comprising:
a container for holding material;
a conduit fitting; and
a material distribution conduit supported by the conduit fitting and having a proximal end communicating with the container and a distal end positioned in the body of water for the distribution of material into the body of water, the material distribution conduit having a conduit length extending between the conduit fitting and the distal end, wherein the conduit length is adjustable.

2. The material distribution system of claim 1, wherein an included angle between a horizontal plane defined generally by the surface of the water and an axis extending from the distal end of the material distribution conduit to a point at which the material distribution conduit intersects the horizontal plane is less than 45 degrees during operation of the material distribution system to distribute material in the body of water.

3. The material distribution system of claim 1, further comprising a sensor for sensing a depth of the distal end of the material distribution conduit below the surface of the water.

4. The material distribution system of claim 3, wherein the sensor includes a GPS-enabled transmitter coupled to the distal end of the material distribution conduit.

5. The material distribution system of claim 3, wherein the sensor includes a depth sensor coupled to the distal end of the material distribution conduit.

6. The material distribution system of claim 1, wherein the material distribution conduit includes a first distribution channel and at least one additional distribution channel coupled to and substantially co-extensive with the first distribution channel.

7. The material distribution system of claim 1, wherein the conduit fitting includes a spool assembly for adjusting the length of the material distribution conduit.

8. The material distribution system of claim 1, wherein the material distribution system is moved along the body of water at a rate of at least about 3 mph and up to about 10 mph while distributing material into the body of water.

9. The material distribution system of claim 1, wherein the material distribution system is moved along the body of water at a rate of about 5 mph.

10. The material distribution system of claim 1, wherein during operation the length of the material distribution conduit is at least twice as long as a depth of the distal end below the surface of the body of water.

11. The material distribution system of claim 1, wherein a depth of the distal end of the material distribution conduit below the surface of the water is altered by adjusting one or both of a rate at which the material distribution system is moved along the body of water and the conduit length.

12. The material distribution system of claim 11, wherein the rate at which the material distribution system is moved along the body of water is at least about 3 mph and up to about 10 mph.

13. A method of adjusting a material discharge depth of an aquatic material distribution system, the method comprising:
extending a material distribution conduit downwardly and rearwardly from a conduit fitting that is supported by a vessel and that is conveyed therewith along a body of water; and
adjusting at least one of a rate at which the material distribution system is moved along the body of water and a length of conduit extending between a distal end of the material distribution conduit and the conduit fitting.

14. The method of claim 13, wherein the conduit fitting includes a spool, and wherein adjusting the length of conduit includes winding and unwinding the material distribution conduit from the spool.

15. The method of claim 13, wherein adjusting the rate at which the material distribution system is moved along the body of water includes adjusting the rate to at least about 3 mph and up to about 10 mph.

16. The method of claim 13, wherein adjusting the rate at which the material distribution system is moved along the body of water includes adjusting the rate such that an included angle between a horizontal plane defined generally by a surface of the water and an axis extending from the distal end of the material distribution conduit to a point at which the material distribution conduit intersects the horizontal plane is less than 45 degrees.

17. The method of claim 13, further comprising sensing a depth of the distal end below a surface of the water.

18. A material distribution system supportable by a vessel and moveable therewith relative to a body of water for distributing material in the body of water, the material distribution system comprising:
a frame;
a container for holding material, the container coupled to the frame;
a material handling assembly for regulating a flow of material out of the container, the material handling assembly including at least one pump for pumping material from the container and at least one valve communicating with the pump;
a material distribution conduit having a proximal end communicating with the container via the material handling assembly, and a distal end positioned in the body of water for the distribution of material;
a conduit fitting coupled to the frame and moveable between an extended position and a retracted position, the conduit fitting supporting the material distribution conduit and operable to change a conduit length defined between the conduit fitting and the distal end of the material distribution conduit;
a depth sensor for sensing a depth of the distal end below a surface of the body of water; and
a control system communicating with the depth sensor and operable to control the at least one pump and the at least one valve to adjust a material distribution rate, and operable to control the conduit fitting to change the conduit length,
wherein changing at least one of the conduit length and a rate at which the material distribution system is moved along the body of water adjusts a material distribution depth, wherein the rate at which the material distribution system is moved along the body of water is at least about 3 mph and up to about 10 mph, and wherein an included angle between a horizontal plane defined generally by the surface of the water and an axis extending from the distal end of the material distribution conduit to a point at which the material distribution conduit intersects the horizontal plane is less than 45 degrees during operation of the material distribution system to distribute material in the body of water.

19. The material distribution system of claim 18, wherein the container is a first container and the material is a first material, the material distribution system further comprising a second container for holding a second material, wherein the at least one pump includes a first pump communicating with the first container and a second pump communicating with the second container, wherein the at least one valve includes a first valve communicating with the first pump, and a second valve communicating with the second pump, wherein the material distribution conduit includes a first distribution channel and a second distribution channel substantially co-extensive with the first distribution channel, the first distribution channel receiving the first material from the first container via the first pump and first valve, and the second distribution channel receiving the second material from the second container via the second pump and the second valve, wherein the control system is operable to control independently the flow of first material through the first distribution channel and the flow of second material through the second distribution channel.

20. The material distribution system of claim 18, wherein during operation of the material distribution system the conduit length is at least twice as long as the depth of the distal end below the surface of the body of water.
